(19) United States
(12) Patent Application Publication
(10) Pub. No.: US 2006/0062541 A1
(43) Pub. Date: Mar. 23, 2006

(54) Method and system for preparing a removable HD for live TV control

(75) Inventor: George Rome Borden, Portland, OR (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/943,616

(22) Filed: Sep. 17, 2004

(51) Int. Cl. H04N 5/76; H04N 5/781

(52) U.S. Cl. 386/46; 386/125

(57) ABSTRACT

A system that provides Personal Video Recorder (PVR) capability determines whether a storage device coupled to the system can be configured for Live TV functionality based on, for example, whether the storage device has at least one of the latency, a data transfer rate and jitter that is acceptable for Live TV control. Additionally, the system determines whether the storage device has sufficient available space for Live TV control. The storage device is configured for Live TV control when the storage device can be configured for Live TV functionality and has sufficient available space for Live TV control. The system also detects when a new storage device is coupled to the system and determines whether the new storage device is capable of being configured for Live TV control.

### BACKGROUND OF THE INVENTION

1. Field of the Invention

The present invention relates to video recording. In particular, the present invention relates to a system and a method for configuring a memory device for Live TV functionality.

2. Description of the Related Art

Devices are known that provide Live TV functionality. As used herein, the term “Live TV functionality” means the ability of a device to provide VCR-like functions on television programming that is received from, for example, an antenna, a CATV system, a cable connection or a satellite dish. VCR-like functions allow a user to, for example, pause, rewind or fast-forward a broadcast-type television signal that cannot normally be controlled in such a manner. In order to provide Live TV functionality, a large file must be pre-allocated in a memory device, such as a hard disk.

When a user presses a Live TV pause button in a conventional system, the system responds by allocating a file for Live TV control on an available storage device, such as a hard disk drive, regardless of the amount of available space for a Live TV control file. Accordingly, in one instance, there may be sufficient space on the storage device for 30 minutes of pause time, and in another instance there may only be available space for two minutes of pause time. Thus, a user may experience what amounts to a variable Live TV pause functionality.

What is needed is a technique that allows a user to experience a consistent Live TV pause functionality.

### SUMMARY OF THE INVENTION

The present invention provides a technique that allows a user to experience a consistent Live TV pause functionality. Additionally, the present invention provides a technique that provides a user selectable amount of Live TV pause functionality.

The advantages of the present invention are provided by a system and a method for configuring a storage device for Live TV functionality. At system power up, the system determines whether a storage device coupled to the system is capable of being configured for Live TV control based on, for example, whether the storage device has at least one of the latency, a data transfer rate and jitter that is acceptable for Live TV control. Additionally, the system determines whether the storage device has sufficient available space for Live TV control based on, for example, whether the storage device can store at least about 30 minutes of video programming. Accordingly, the storage device is configured for Live TV control when the storage device has sufficient available space for Live TV control. In that regard, the system can configure the storage device for Live TV control by allocating only a portion of the available space of the storage device for Live TV control. When the system contains more than one storage device, the system determines whether the second storage device is capable of being configured for Live TV control based on whether the second storage device has, for example, at least one of the latency, a data transfer rate and jitter that is acceptable for Live TV control. The system also determines whether the second storage device has sufficient available space for Live TV control based on, for example, whether the second storage device can store at least about 30 minutes of video programming. The system configures the second storage device for Live TV control when the storage device has sufficient available space for Live TV control. Accordingly, the system can configure the second storage device for Live TV control by allocating only a portion of the available space of the storage device for Live TV control. Each storage device of the system could be, for example, a hard disk drive, an optical disk drive, a random access memory and/or a networked storage medium.

The present invention also detects when a new storage device is coupled to the system and determines whether the new storage device is capable of being configured for Live TV control. Additionally, the system determines whether the new storage device has sufficient available space for Live TV control when the storage device is capable of being configured for Live TV control. The new storage device is configured for Live TV control when the storage device has sufficient available space for Live TV control.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of an exemplary television system that provides personal video recorder (PVR) capability and Live TV functionality according to the present invention;

FIG. 2 depicts an exemplary flow diagram of a process for configuring a storage device for providing Live TV functionality according to the present invention;

FIG. 3 depicts an exemplary flow diagram for configuring a storage device for providing Live TV functionality according to the present invention when a storage device is added to the exemplary television system shown in FIG. 1; and

FIG. 4 depicts an exemplary flow diagram of a process for configuring a storage device for providing a user-selectable amount of Live TV functionality according to the present invention.

### DETAILED DESCRIPTION OF THE PRESENT INVENTION

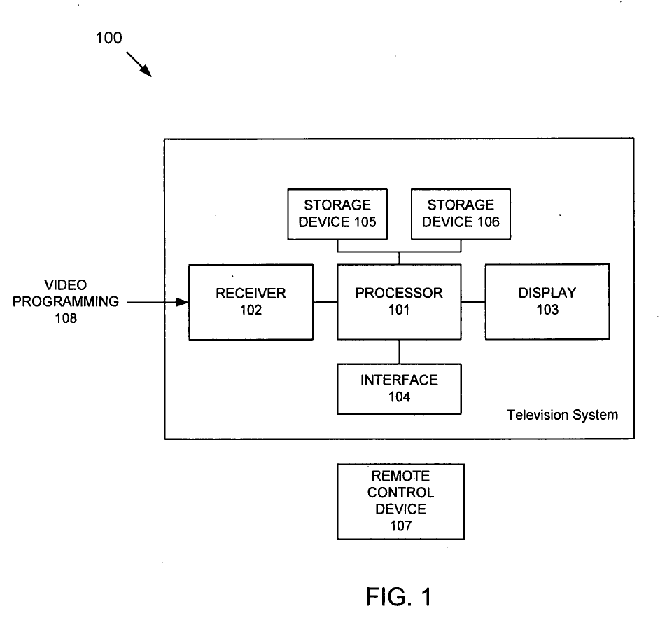

FIG. 1 depicts a functional block diagram of an exemplary television system 100 that provides personal video recorder (PVR) capability and Live TV functionality according to the present invention. Television system 100 includes a processor 101, a receiver portion 102, a display 103, a user interface 104, and media storage devices 105 and 106. User interface 104 interfaces with a remote control device 107 in a well-known manner. Alternatively or additionally, user interface 104 includes, for example, a keypad, switches and/or other similar-type control buttons that allow a user to input commands to television system 100 without using remote control device 107.

Processor 101 provides PVR and Live TV control functionality in addition to being able to provide video-processing capabilities, such as decoding MPEG-type encoded video information. Receiver 102 receives video programming 108 from, for example, an antenna, CATV, cable or satellite dish, each of which is not shown in FIG. 1. While display 103 is depicted as part of television system 100, it should be understood that a separate display device, such as a CRT-type display or an LCD-type display, could be used with television system 100.

Storage devices 105 and 106 are typically disk drives and provide television system 100 with the capability to PVR functionality. That is, television system 100 can be configured to record and replay live video broadcasts with a VCR-like features, such as pause, rewind and fast-forward. One or both of storage devices 105 and 106 can be removable from television system 100 in a well-known manner by using a disk slot (not shown). While storage devices 105 and 106 are described as being disk drives, it should be understood that storage devices 105 and 106 could be another type of storage device, such as an optical drive, a volatile, and/or a non-volatile Random Access Memory (RAM) and/or a networked storage medium, such as a hard disk drive, an optical drive and/or a volatile or non-volatile RAM storage medium connected to a network, as long as the memory device has a latency, a data transfer rate and a jitter that is acceptable for Live TV control.

During start-up (i.e., power up) of television system 100 having Personal Video Recorder (PVR) capability, slots for disks 105 and 106 are checked to determine whether there is already a disk inserted into a slot that has been designated to use for Live TV control. When a Live TV-enabled disk is found, Live TV control is enabled with no interaction with the user being required. When a disk is found that is not Live TV-enabled, a user is queried whether they wish to use the disk for Live TV control. If a user does, a file is allocated on the disk for Live TV control, and Live TV control is enabled. Otherwise, Live TV control is not enabled and no further interaction with the user takes place.

When a disk is added to system 100 when the system is powered up, system 100 first checks whether Live TV control has been enabled (i.e., whether a Live TV-enabled disk is in another disk slot of the system.) If not, then a newly inserted disk is examined to determine whether it is suitable for Live TV control. When the newly inserted disk is suitable for Live TV control, a user is queried whether they would like to use the newly inserted disk for Live TV control. When the user does, a file is allocated for Live TV control and Live TV control is enabled. Otherwise, Live TV control is not enabled and no further interaction with the user takes place.

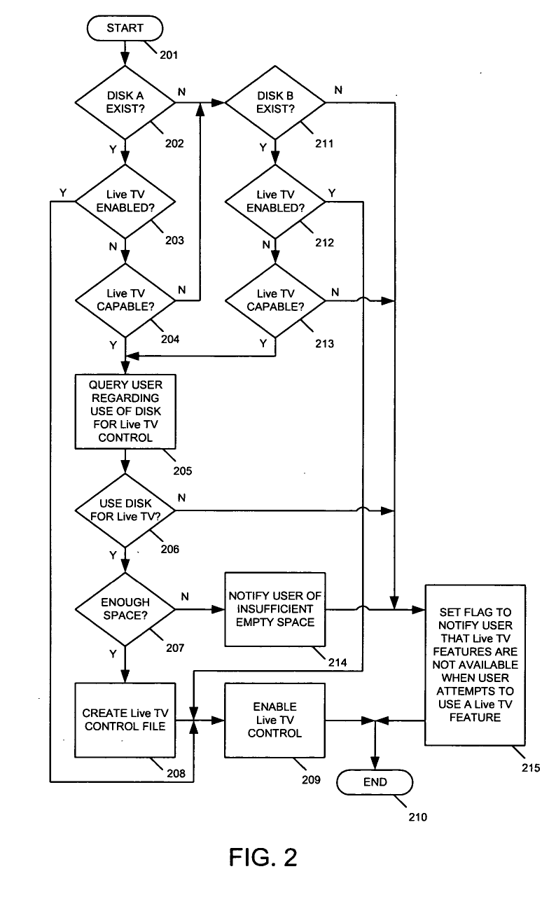

FIG. 2 depicts an exemplary flow diagram 200 of a process for configuring a storage device for providing Live TV functionality according to the present invention. The process starts at step 201 when television system 100 is powered on or is reset. Flow continues to step 202 where it is determined whether disk 105 is part of television system 100, that is, whether disk 105 is inserted into the disk slot for disk 105. If, at step 202, it is determined that disk 105 is not part of television system 100, flow continues to step 211. If, at step 202, it is determined that disk 105 is part of television system 100, flow continues to step 203 where it is determined whether disk 105 has been previously enabled to provide Live TV functions. If so, flow continues to step 209. If not, flow continues to step 204 where it is determined whether disk 105 is capable of being used for Live TV functionality. That is, it is determined whether disk 105 has, for example, a latency, a data transfer rate and a jitter that is compatible with Live TV functionality. If so, flow continues to step 205.

At step 211, it is determined whether disk 106 is part of television system 100. If not, flow continues to step 215. If, at step 211, it is determined that disk 106 is part of television system 100, flow continues to step 212 where it is determined whether disk 106 has been previously enabled to provide Live TV functions. If so, flow continues to step 209. If not, flow continues to step 213 where it is determined whether disk 106 is capable of being used as part of a PVR and for Live TV functionality. That is, it is determined whether disk 106 has a latency, a data transfer rate and a jitter that is compatible with Live TV functionality. If not, flow continues to step 215. If so, flow continues to step 205.

It should be understood that the determination made at step 211 and subsequent determinations at steps 212 and 213 relating to disk 106 could be performed before the corresponding determinations are made with respect to disk 105. Additionally, the determinations made at steps 202-204 and at 211-213 are quick determinations in order to minimize the delay between the time a user presses a Live TV function button and the time when television system 100 responds. The acceptable delay between the time that a user presses a Live TV pause button and the time when the Live TV pause function begins is at most only a few seconds. Ideally, such a delay should be less than about one second.

At step 205, the user is queried whether the user would like to enable disk 105 (or disk 106) for Live TV control. For example, television system 100 can cause to display a message such as, “The disk in slot 1 is suitable for Live TV PVR features such as pausing live TV. Do you wish to use configure the disk for Live TV PVR features?” When the process arrives at step 205 from step 204, the user is queried regarding disk 105. When the process arrives at step 205 from step 213, the user is accordingly queried regarding disk 106. After the user responds to the query, flow continues to step 206 where it is determined whether the response of the user is enable the disk for Live TV control. If not, flow continues to step 215. If so, flow continues to step 207 where it is determined whether the disk has sufficient available storage capacity to be used for providing Live TV functions. In particular, at step 207 it is determined whether the disk has at least 1 GB of available space in order for providing a user with the ability to pause live shows, rewind live shows, and to view high-quality freeze frames.

If not, flow continues to step 214 where television system 100 causes a message to be displayed indicated to the user that there is not enough available empty space on the disk. Flow continues to step 215. If, at step 207, it is determined that there is enough available space on the disk, flow continues to step 208 where a Live TV control file is created on the disk having a fixed amount of Live TV pausing capability, such as 30 minutes.

At step 209, Live TV control is enabled and flow continues to step 210, where the process ends for configuring a disk at power on or at reset for providing Live TV control.

At step 215, a flag is set so that when a user attempts to use a Live TV function, television system 100 causes a message to be displayed indicating that Live TV functions are not available. Flow continues to step 210, where the process ends for configuring a disk at power on or at reset for providing Live TV control.

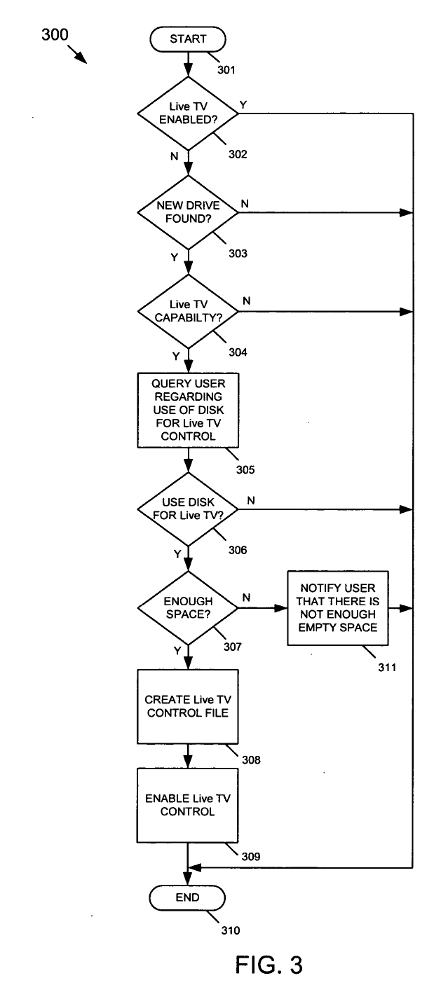

FIG. 3 depicts an exemplary flow diagram 300 for configuring a storage device for providing Live TV functionality according to the present invention when a storage device is added to exemplary television system 100, which is shown in FIG. 1. The process starts at step 401 when a new storage device has been inserted into an available disk slot of television system 100. It should be understood that that the new storage device could be a hard disk drive, an optical drive, a volatile and/or a non-volatile Random Access Memory (RAM) and/or a networked storage medium, such as a hard disk drive, an optical drive, and/or a volatile and/or a non-volatile RAM storage medium connected to a network, as long as the memory device has a latency, a data transfer rate and a jitter that is acceptable for Live TV control. Flow continues to step 402 where it is determined whether Live TV control has been previously enabled. If not, flow continues to step 403, otherwise flow continues to step 410.

At step 403, it is determined whether a new storage device has been inserted into television system 100. If so, flow continues to step 304, otherwise flow continues to step 310.

At step 304, it is determined whether the newly inserted storage device is capable of being used for Live TV functionality. That is, it is determined whether the newly inserted storage device has, for example, a latency, a data transfer rate and a jitter that is compatible with Live TV functionality. If so, flow continues to step 304, otherwise flow continues to step 310.

At step 305, the user is queried whether the user wants to use the storage device as a Live TV control disk. When the user responds, flow continues to step 306 where it is determined whether the user wants to use the storage device as a Live TV control disk. If so, flow continues to step 307, otherwise flow continues to step 310. At step 307, it is determined whether the storage device has enough available space. If so, flow continues to step 308, otherwise flow continues to step 311 where the user is notified that the storage device does not have enough empty space. Flow then continues to step 310.

At step 308, a Live TV control file is created and flow continues to step 309 where Live TV control is enabled. Flow continues to step 310, where the process ends for configuring a storage device for Live TV control when a storage device is added to exemplary television system 100.

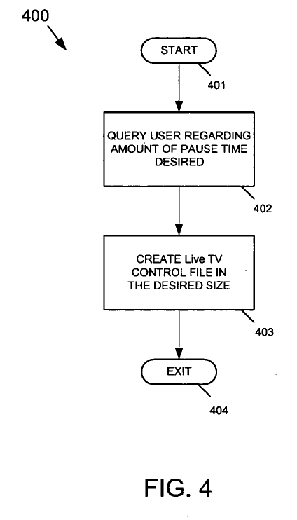

As an alternative embodiment, a user could be queried for the amount of Live TV pause time that the user desires. For example, FIG. 4 depicts an exemplary flow diagram 400 of a process for configuring a storage device for providing a user-selectable amount of Live TV functionality according to the present invention. The process depicted by FIG. 4 could be performed during step 208 in FIG. 2 and during step 308 in FIG. 3. Process 400 starts at step 401 and continues to step 402 where a user is queried at to the amount of Live TV pause time that is desired. Accordingly, if there were only 30 minutes of available space on a storage device, the user would only be able to select up to 30 minutes of Live TV pause time. Similarly, if there were only available space for only ten minutes of Live TV pause time, the user would only be able to select up to ten minutes of Live TV pause time. The user could select a Live TV pause time that is less than the full amount that is available.

Flow continues to step 403 where a Live TV control file of the desired size is created and flow continues to step 309 where the process is exited.

While system 100 has been described as a television system, it should be understood that system 100 could also be a computer-based system, such as a personal computer (PC) or a laptop computer.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for configuring a storage device for Live TV functionality, the method comprising:
determining whether a storage device is capable of being configured for Live TV control;
determining whether the storage device has sufficient available space for Live TV control when the storage device is capable of being configured for Live TV control; and
configuring the storage device for Live TV control when the storage device has sufficient available space for Live TV control.

2. The method according to claim 1, wherein determining whether the storage device is capable of being configured for Live TV control includes determining whether the storage device has at least one of a latency, a data transfer rate and a jitter that is acceptable for Live TV control.

3. The method according to claim 1, wherein determining whether the storage device has sufficient available space for Live TV control includes determining whether the storage device has sufficient space for storing at least about 30 minutes of video programming.

4. The method according to claim 1, wherein configuring the storage device for Live TV control includes allocating at least a portion of the available space of the storage device for Live TV control.

5. The method according to claim 1, further comprising:
determining whether a second storage device is capable of being configured for Live TV control;
determining whether the second storage device has sufficient available space for Live TV control when the second storage device is capable of being configured for Live TV control; and
configuring the second storage device for Live TV control when the storage device has sufficient available space for Live TV control.

6. The method according to claim 5, wherein determining whether the second storage device is capable of being configured for Live TV control includes determining whether the second storage device has at least one of a latency, a data transfer rate and a jitter that is acceptable for Live TV control.

7. The method according to claim 5, wherein determining whether the second storage device has sufficient available space for Live TV control includes determining whether the second storage device has sufficient space for storing at least about 30 minutes of video programming.

8. The method according to claim 1, wherein the storage device is a hard disk drive.

9. The method according to claim 1, wherein the storage device is an optical disk drive.

10. The method according to claim 1, wherein the storage device is a random access memory.

11. The method according to claim 1, wherein the storage device is a networked storage medium.

12. The method according to claim 1, further comprising:
detecting a new storage device;
determining whether the new storage device is capable of being configured for Live TV control;
determining whether the new storage device has sufficient available space for Live TV control when the storage device is capable of being configured for Live TV control; and
configuring the new storage device for Live TV control when the storage device has sufficient available space for Live TV control.

13. The method according to claim 12, wherein determining whether the new storage device is capable of being configured for Live TV control includes determining whether the new storage device has at least one of a latency, a data transfer rate and a jitter that is acceptable for Live TV control.

14. The method according to claim 12, wherein determining whether the new storage device has sufficient available space for Live TV control includes determining whether the new storage device has sufficient space for storing at least about 30 minutes of video programming.

15. The method according to claim 12, wherein configuring the new storage device for Live TV control includes allocating at least a portion of the available space of the storage device for Live TV control.

16. A method for configuring a storage device for Live TV functionality, the method comprising:
detecting a new storage device;
determining whether the new storage device is capable of being configured for Live TV control;
determining whether the new storage device has sufficient available space for Live TV control when the storage device is capable of being configured for Live TV control; and
configuring the new storage device for Live TV control when the storage device has sufficient available space for Live TV control.

17. The method according to claim 16, wherein determining whether the new storage device is capable of being configured for Live TV control includes determining whether the new storage device has at least one of a latency, a data transfer rate and a jitter that is acceptable for Live TV control.

18. The method according to claim 16, wherein determining whether the new storage device has sufficient available space for Live TV control includes determining whether the new storage device has sufficient space for storing at least about 30 minutes of video programming.

19. The method according to claim 16, wherein configuring the new storage device for Live TV control includes allocating at least a portion of the available space of the storage device for Live TV control.

20. The method according to claim 16, wherein the new storage device is a hard disk drive.

21. The method according to claim 16, wherein the new storage device is an optical disk drive.

22. The method according to claim 16, wherein the new storage device is a random access memory.

23. The method according to claim 16, wherein the new storage device is a networked storage medium.

24. A system, comprising:
a receiver receiving video programming; and
a processor determining whether a storage device coupled to the system has sufficient available space for Live TV control when the storage device is capable of being configured for Live TV control, the processor configuring the storage device for Live TV control when the storage device has sufficient available space for Live TV control.

25. The system according to claim 24, wherein the processor further determines whether a storage device is capable of being configured for Live TV control.

26. The system according to claim 25, wherein the processor determines whether the storage device is capable of being configured for Live TV control based on whether the storage device has at least one of a latency, a data transfer rate and a jitter that is acceptable for Live TV control.

27. The system according to claim 24, wherein the processor determines whether the storage device has sufficient available space for Live TV control based on whether the storage device has sufficient space for storing at least about 30 minutes of video programming.

28. The system according to claim 24, wherein the processor configures the storage device for Live TV control by allocating at least a portion of the available space of the storage device for Live TV control.

29. The system according to claim 24, wherein the processor determines whether a second storage device coupled to the system has sufficient available space for Live TV control when the second storage device is capable of being configured for Live TV control, and
wherein the processor configures the second storage device for Live TV control when the storage device has sufficient available space for Live TV control.

30. The system according to claim 29, wherein the processor determines whether the second storage device is capable of being configured for Live TV control.

31. The system according to claim 30, wherein the processor determines whether the second storage device is capable of being configured for Live TV control based on whether the second storage device has at least one of a latency, a data transfer rate and a jitter that is acceptable for Live TV control.

32. The system according to claim 30, wherein the processor determines whether the second storage device has sufficient available space for Live TV control based on whether the second storage device has sufficient space for storing at least about 30 minutes of video programming.

33. The system according to claim 24, wherein the storage device is a hard disk drive.

34. The system according to claim 24, wherein the storage device is an optical disk drive.

35. The system according to claim 24, wherein the storage device is a random access memory.

36. The system according to claim 24, wherein the storage device is a networked storage medium.

37. The system according to claim 24, wherein when the processor detects a new storage device coupled to the system, the processor determines whether the new storage device has sufficient available space for Live TV control when the storage device is capable of being configured for Live TV control, and configures the new storage device for Live TV control when the storage device has sufficient available space for Live TV control.

38. The system according to claim 37, wherein the processor determines whether the new storage device is capable of being configured for Live TV control.

39. The system according to claim 38, wherein the processor determines whether the new storage device is capable of being configured for Live TV control based on whether the new storage device has at least one of a latency, a data transfer rate and a jitter that is acceptable for Live TV control.

40. The system according to claim 37, wherein the processor determines whether the new storage device has sufficient available space for Live TV control based on determining whether the new storage device has sufficient space for storing at least about 30 minutes of video programming.

41. The system according to claim 37, wherein the processor configures the new storage device for Live TV control by allocating at least a portion of the available space of the storage device for Live TV control.

42. A system, comprising:
a receiver receiving video programming; and
a processor detecting a new storage device coupled to the system, determining whether the new storage device has sufficient available space for Live TV control when the storage device is capable of being configured for Live TV control, and configuring the new storage device for Live TV control when the storage device has sufficient available space for Live TV control.

43. The system according to claim 42, wherein the processor determines whether the new storage device is capable of being configured for Live TV control.

44. The system according to claim 43, wherein the processor determines whether the new storage device is capable of being configured for Live TV control based on whether the new storage device has at least one of a latency, a data transfer rate and a jitter that is acceptable for Live TV control.

45. The system according to claim 42, wherein the processor determines whether the new storage device has sufficient available space for Live TV control based on whether the new storage device has sufficient space for storing at least about 30 minutes of video programming.

46. The system according to claim 42, wherein the processor configures the new storage device for Live TV control by allocating at least a portion of the available space of the storage device for Live TV control.

47. The system according to claim 42, wherein the new storage device is a hard disk drive.

48. The system according to claim 42, wherein the new storage device is an optical disk drive.

49. The system according to claim 42, wherein the new storage device is a random access memory.

50. The system according to claim 42, wherein the new storage device is a networked storage medium.
